(19) United States
(12) Patent Application Publication
(10) Pub. No.: US 2014/0107809 A1
(43) Pub. Date: Apr. 17, 2014

(54) METHOD AND A SYSTEM FOR ONLINE AND DYNAMIC SCHEDULE CONFIGURATION OF CONTROL APPLICATIONS IN A DISTRIBUTED CONTROL SYSTEM

(71) Applicant: ABB TECHNOLOGY LTD, Zurich (CH)

(72) Inventors: Sanjay GHOSH, Bangalore (IN); Atul Kumar D, Dehradun (IN); Michael WAHLER, Zurich (CH); Srini RAMASWAMY, Bangalore (IN); Rakesh REDDY, Hyderabad (IN)

(73) Assignee: ABB TECHNOLOGY LTD, Zurich (CH)

(21) Appl. No.: 14/137,516

(22) Filed: Dec. 20, 2013

Related U.S. Application Data
(63) Continuation of application No. PCT/IB2011/003148, filed on Dec. 23, 2011.

(30) Foreign Application Priority Data
Jun. 20, 2011 (IN) 2069/CHE/2011

(51) Int. Cl. G05B 15/02

(52) U.S. Cl. CPC G05B 15/02
USPC 700/9

(57) ABSTRACT

The disclosure relates to a method of online and dynamic schedule configuration of control applications in a Distributed Control System (DCS). The disclosure considers having a DCS with a plurality of controllers, where controllers include one or more of source controllers and one or more of destination controllers. The method of the disclosure can includes the steps of: a) selecting one or more blocks of control applications; b) identifying one or more potential slots for executing blocks in one or more destination controllers; c) publishing the information pertaining to one or more of the identified potential slots to a central management entity or to source controllers; d) determining the one or more potential slots and corresponding block by the central management entity or source controller; e) proposing a schedule configuration of control applications; and f) performing schedulability analysis for each block or logical combination thereof.

### RELATED APPLICATION

This application claims priority as a continuation application under 35 U.S.C. §120 to PCT/IB2011/003148, which was filed as an International Application on Dec. 23, 2011 designating the U.S., and which claims priority to Indian Application 2069/CHE/2011 filed in India on Jun. 20, 2011. The entire contents of these applications are hereby incorporated by reference in their entireties.

### FIELD

The disclosure relates to control applications in a distributed control system, and for example to a method and a system for online and dynamic schedule configuration of control applications in distributed control system.

### BACKGROUND INFORMATION

Generally, Distributed Control System (DCS) are employed in a process control plant for controlling the processes in the plant. DCS has real time controllers which include but not limited to general or industrial Personal Computer (PC), Programming Logic Controller (PLC), any computing unit capable of providing real time execution environment to control applications, etc., and are used to manage real time control applications, communication interfaces, field devices and so forth through industrial automation.

The processes involved in process control industry are characterized by factors relating, for example, to hardware, control applications, workflow, etc. These control applications are executed in the controllers based on the schedule of the control applications. Currently, the scheduling or schedule configuration of control applications or its parts thereof for their execution is done in a predetermined manner before the execution of the control applications. Also, it can be understood that the schedule configuration can be limited to each controller, since in the present DCS the control applications or its parts thereof are not being shared or migrated across other controllers dynamically in real time.

It becomes desireable to have a schedule configuration of control applications in a DCS, where the execution of control applications or of its parts thereof are scheduled dynamically in real time, and considering one or more of online migration, sharing, modification or the like, of the control applications within or amongst one or more controllers in DCS.

### SUMMARY

A method of online and dynamic schedule configuration of control applications in a Distributed Control System (DCS) having a plurality of controllers, wherein the method comprises: selecting one or more blocks of control applications, in one or more source controllers that can be migrated across one or more destination controllers; identifying one or more potential slots for executing blocks in one or more destination controllers, that can be employed for accommodating the selected one or more blocks of control applications accordingly; publishing information pertaining to one or more of the identified potential slots to a central management entity or to a corresponding one or more of said source controllers by the one or more destination controllers; determining said one or more potential slots and a corresponding said selected block thereto for each destination controller accordingly by the central management entity or by the one or more source controllers; proposing a schedule configuration of control applications by the central management entity or by the one or more source controllers; and performing schedulability analysis for each of the one or more blocks or of a logical combination thereof.

A system for performing online and dynamic schedule configuration of control applications in a Distributed Control System (DCS), comprising: a plurality of controllers, configured to perform the method as claimed in claim 1, the plurality of controllers including one or more source controllers and one or more destination controllers; and a central management entity provided separately or of similar component provided within one or more source controllers, for determining one or more potential slots and a corresponding selected block thereto for each destination controller accordingly, proposing a schedule configuration of control applications, and performing schedulability analysis for each of the one or more blocks or of its logical combination thereof.

### BRIEF DESCRIPTION OF THE DRAWINGS

Exemplary embodiments will be described with reference to the accompanying drawings in which:

FIG. 1 shows a flow chart depicting a method of the disclosure by way of exemplary embodiment; and

FIG. 2 shows an exemplary schedule configuration of control applications in accordance with an exemplary proposed method of the disclosure.

### DETAILED DESCRIPTION

A method of schedule configuration of control applications is disclosed which method is dynamic and performed online.

An exemplary method of schedule configuration of control applications or of parts thereof is disclosed.

An exemplary method of schedule configuration of control applications in or across one or more controllers is also disclosed.

Another exemplary method is disclosed of schedule configuration of control applications catering to efficient migration workflow of control applications.

Another exemplary method is disclosed of schedule configuration of control applications that considers and accounts for changes relating to control applications such as adding, deleting, modifying and cascading etc. of control applications, and of the control schemes of the plant thereof.

An exemplary system for performing the methods described herein is disclosed as well.

Accordingly the disclosure provides a method of online and dynamic schedule configuration of control applications in a Distributed Control System (DCS). The disclosure considers having a DCS with a plurality of controllers, where controllers include one or more of source controllers and one or more of destination controllers. An exemplary method of the disclosure can include steps of: a) selecting one or more blocks of control applications in a desired (e.g., an optimal) manner; such blocks of control applications in one or more source controllers can be migrated across one or more destination controllers; b) identifying one or more potential slots for executing blocks in one or more destination controllers; these potential slots are employed for accommodating the selected one or more blocks of control applications accordingly; c) publishing the information pertaining to one or more of the identified potential slots to a central management entity or to corresponding one or more of the source controllers by the one or more destination controllers; d) determining the one or more potential slots and its corresponding selected block thereto for each destination controller accordingly by the central management entity or by the one or more source controllers; e) proposing a schedule configuration of control applications by the central management entity or by the one or more source controllers; and f) performing schedulability analysis for each of the one or more blocks or of its logical combination thereof.

The disclosure also provides an exemplary system for performing online and dynamic schedule configuration of control applications in a Distributed Control System (DCS), in accordance with exemplary methods of the disclosure. An exemplary system can include: a) a plurality of controllers including one or more source controllers and one or more destination controllers; and b) a central management entity for determining one or more potential slots for executing blocks and its corresponding selected block thereto for each destination controller accordingly, proposing a schedule configuration of control applications, and performing schedulability analysis for each of the one or more blocks or of its logical combination thereof. A central management entity for purposes disclosed herein can be provided separately or a similar component can be provided within one or more source controllers.

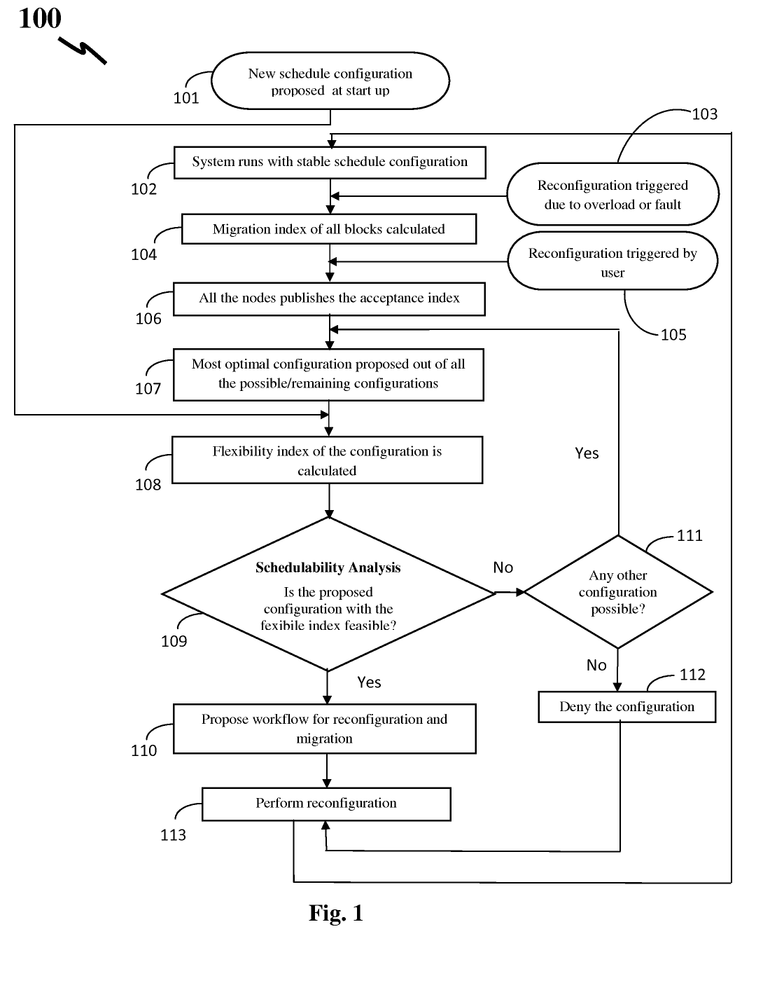

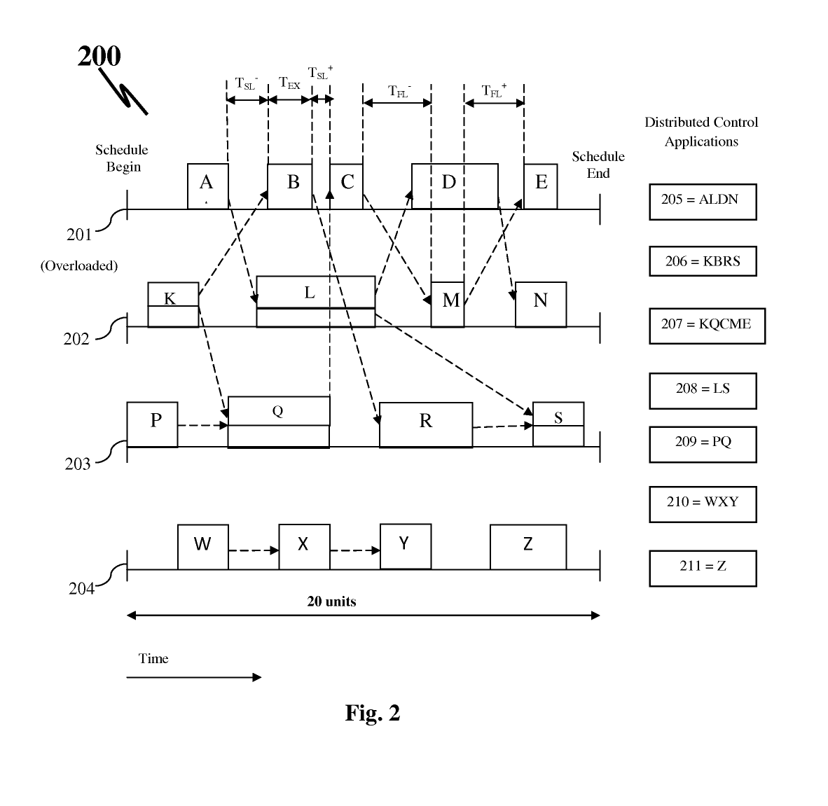

Exemplary embodiments of the disclosure will be explained in detail with reference to FIGS. 1 and 2 by way of non-exhaustive exemplary embodiments. In FIG. 1, the flow chart depicts an exemplary method (100) of the disclosure performed by a system in a Distributed Control System (DCS). DCS has a plurality of controllers.

As shown in FIG. 1, a schedule configuration of control applications is proposed initially (101), and a flexibility index of the configuration is calculated (108). The flexibility index is a measure pertaining to the flexibility of the configuration to adapt to any further change in configuration, and can, for example, be calculated as follows:

### Flexibility Index,

$${I}_{F} = f ( {{\sum }_{b ∈ S}}^{b} {I}_{M} , {{\sum }_{n ∈ S}}^{n} {I}_{A} )$$

where,
‘b’ is block; ‘n’ is node; ‘S’ is system;
b∈n means ‘block’ belongs to ‘node’;
n∈S means ‘node’ belongs to ‘System’;
I_{M} is migration index; and
I_{A} is acceptance index

An exemplary desired (e.g., optimal) configuration can have I_{F} ≈I_{F max} (e.g., high Flexibility Index) and, I_{Lnode}<I_{L threshold}∀n∈S (e.g., Node Load Index below threshold for all nodes in the system). Accordingly, a schedulability analysis can be performed to check the feasibility of the configuration with the flexibility index (109). This can be done based on factors that include, but are not limited to, time guarantees, execution sequence of the blocks or of the control applications, overall stability, etc. With the possibility of the configuration being feasible, a workflow for reconfiguration of control applications, and migration thereof if any, is proposed (110) and reconfiguration is performed (113) by the central management entity. However, if the configuration is not feasible, other possible configuration(s) are considered (111).

When the other configuration(s) become possible, a most suitable and/or desired or optimal configuration can be identified or selected from all of such possible configurations (107). Thereafter, steps commencing from 108, described immediately herein above can be followed. If at 111, there are no other configurations possible, the schedule configuration proposed at 101 is denied or rejected (112), and the system runs with the stable schedule configuration that has currently been adopted or that has been in place (102).

Considering, that the system is running with a stable schedule configuration (102), which scenario being independent or coextensively applied to that described herein before, the schedule configuration of control applications can be performed dynamically during run time. The schedule configuration can be triggered (103, 105) either voluntarily or involuntarily due to many reasons that can include situations arising out of overload, fault, etc.

Accordingly, one or more blocks of control applications corresponding to one or more source controllers can be selected for migrating them from the source controller to one or more suitable and/or optimally selected destination controllers. The block or blocks of control application referred herein are independent logical block(s) that are a block or portion of the corresponding application or of control application. These blocks can be independently executable and have respective runtime state and data. Also, these blocks can be capable of communicating and sharing runtime state and data with one or more of other blocks in the same application or of that in other application belonging to the same controller or other controller.

Here, the source controller refers to the controller from which control applications or its blocks are migrated. The destination controllers are the controllers to which the control applications or its blocks from the source controller are being moved to. It is to be noted that at any point of time, any source controller can also coexist as a destination controller concurrently and vice versa.

Selecting the blocks for migration in an optimal manner can include calculating migration index for all the blocks (104). The migration index is a measure of a favorable portion or block of a control application that can be migrated, and is calculated as follows:

Migration Index, I_{M}=f(T_{EX},T_{FL},T_{SL},I_{Rblock},C_{COM},C_{RT},L_{block})

where,
T_{EX}=Execution Time, which is the time duration between the start and end of execution of a block;
T_{FL}=Float Time, which is the time duration between the end of the execution of a block and start of execution of the next linking block in a control application;
T_{SL}=Slack Time, which is the time duration between the end of the execution of a block and start of execution of the next block in the schedule of a node;
C_{COM} (Communication Cost) is a measure of communication overhead for communication between the distributed linked blocks. For example, C_{COM} is negligible when the linked blocks (distributed portions/blocks of a control application) are executed in the schedule of the same controller. C_{COM} is high if the linked blocks are executing on different controllers. C_{COM} of a block is higher if its adjacent linked blocks are scattered on a different controller(s) instead of executing in the same controller. Blocks with high C_{COM} are more flexible for migration;
C_{RT} (Real Time constraint Cost) is high for the blocks with hard real time constraints and low for the blocks without hard real time constraints. Blocks with low C_{RT} are more flexible for migration;
P_{IN}/P_{OUT} (Ports IN/OUT) is respective number of communication ports of a block in use;
L_{block} (Block Load) is runtime execution load due to the block; and
I_{Rblock} (Block Reliability Index) is a measure of reliability of the block.

Further, one or more potential slots in one or more of the destination controllers are identified. These potential slots for executing block(s) are the schedule slots that can accommodate one or more of the selected blocks for migration and execute them. The nodes pertaining to the one or more destination controllers participating in the configuration schedule publishes the information corresponding to the potential slot(s) and of its respective acceptance index, to the central management entity (106). The acceptance index is a measure of favorable acceptance of a controller schedule to accommodate a migrating portion of a control application. An acceptance index can be calculated as follows:

Acceptance Index, I_{A}=f(I_{Lnode},I_{Rnode});

where,

I_{Lnode},(Node Load Index)=f(L_{PROC},L_{MEM},L_{COM});

$${I}_{Rnode} = ( Node Reliability Index ) = {{\sum }_{b ∈ n}}^{n} {I}_{Rblock}$$

i.e. sum of I_{Rblock} for all blocks in the node;
L_{PROC} (Processing Load) is a measure of load on the node due to processing specifications of the running applications;
L_{MEM} (Memory Load) is a measure of load on the node due to memory specifications of the running applications; and
L_{COM} (Communication Load) is a measure of communication load on the node due to communication between the distributed portions of control applications.

Following this, the method can involve proposing an optimal configuration (107) and calculating flexibility index (108), and other steps 109 through 113, as explained in the description herein.

It is to be noted that similar entities purporting to be a central management entity or its equivalent or the like can be available within one or more source controllers and as applicable. Therefore, even in the absence of an explicit central management entity, exemplary purposes as discussed herein can be accomplished by one or more source controllers accordingly.

FIG. 2 shows an example in which a stable schedule configuration (200) with four controllers/nodes (201, 202, 203 and 204) is running with seven distributed control applications (205 to 211). These control applications (205 to 211) accordingly have their respective blocks (A, B, C, D, E, K, L, M, N, P, Q, R, S, W, X, Y and Z).

Here, it is shown that a trigger for schedule reconfiguration due to overload (103) is occurring in node (201). The workflow in accordance with an exemplary method of the disclosure gets initiated. This overload situation in node (201) can be handled by migrating one of the blocks dynamically from node (201) to any of the other nodes (202, 203, 204). A migration index of each of the blocks (A, B, C, D and E) in node (201) is calculated. One of the proposed desired (e.g., optimal) configurations could be migrating block (B) from node (201) to node (202) and scheduling block (B) after block (K) and before block (L) in node (202). If the proposed configuration is found to be feasible (109) with regard to the feasibility index and of the feasibility analysis thereof, the migration workflow is proposed to migrate block (B) from node (201) to node (202). After the migration is successful, the system runs stably with a new schedule configuration until a trigger for reconfiguration occurs.

The disclosure also includes embodiments that can cater to or allow dynamic changes to the control application that include but are not limited to adding, deleting, modifying, cascading etc. of additional or new control schemes of a plant, changes to the logic or algorithm of a control application, etc.

The disclosure is not restricted by the exemplary embodiments described herein in the description. It is to be noted that the disclosure is explained by way of exemplary embodiments and is neither exhaustive nor limiting. Certain aspects of the disclosure that not been elaborated herein in the description are well understood by one skilled in the art. Also, the terms relating to singular form used herein in the description also include its plurality and vice versa, wherever applicable. Any relevant modification or variation, which is not described specifically in the specification are in fact to be construed as being well within the scope of the disclosure.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of online and dynamic schedule configuration of control applications in a Distributed Control System (DCS) having a plurality of controllers, wherein the method comprises:
selecting one or more blocks of control applications, in one or more source controllers that can be migrated across one or more destination controllers;
identifying one or more potential slots for executing blocks in one or more destination controllers, that can be employed for accommodating the selected one or more blocks of control applications accordingly;
publishing information pertaining to one or more of the identified potential slots to a central management entity or to a corresponding one or more of said source controllers by the one or more destination controllers;
determining said one or more potential slots and a corresponding said selected block thereto for each destination controller accordingly by the central management entity or by the one or more source controllers;
proposing a schedule configuration of control applications by the central management entity or by the one or more source controllers; and
performing schedulability analysis for each of the one or more blocks or of a logical combination thereof.

2. The method as claimed in claim 1, wherein the block is an independent logical block, being a block or portion of the corresponding application or of a control application which is independently executable, and having respective runtime state and data, and capable of communicating and sharing runtime state and data with one or more of other blocks in a same application or of that in another application belonging to a same controller or another controller.

3. The method as claimed in claim 1, wherein the one or more applications or control applications is capable of its execution being independent of the controller.

4. The method as claimed in claim 1, wherein selecting one or more blocks of control applications includes identifying blocks of control applications in the one or more source controllers and performing comparative ranking of the said identified blocks based on the feasibility and potential thereof of the said blocks for migration.

5. The method as claimed in claim 1, wherein selecting one or more blocks of control applications, is based on one or more of block level indices.

6. The method as claimed in claim 1, wherein identifying one or more potential slots in one or more destination controllers, is based on one or more of the node level indices.

7. The method as claimed in claim 1, wherein performing schedulability analysis for each of the one or more blocks or of a logical combination thereof, is based on one or more factors.

8. The method as claimed in claim 1, wherein allowing one or more of dynamic changes is provided which include at least one of adding, deleting, modifying, or cascading of control schemes of a plant, or changes to the logic or algorithm of a control application.

9. The method as claimed in claim 1, being performed online or during operation of the one or more controllers or of a plant thereof, maintaining operation of the one or more controllers or of the plant and of the sequence of operation therein.

10. A system for performing online and dynamic schedule configuration of control applications in a Distributed Control System (DCS), comprising:
a plurality of controllers, configured to perform the method as claimed in claim 1, the plurality of controllers including one or more source controllers and one or more destination controllers; and
a central management entity provided separately or of similar component provided within one or more source controllers, for determining one or more potential slots and a corresponding selected block thereto for each destination controller accordingly, proposing a schedule configuration of control applications, and performing schedulability analysis for each of the one or more blocks or of its logical combination thereof.

11. The method as claimed in claim 2, wherein the one or more applications or control applications is capable of its execution being independent of the controller.

12. The method as claimed in claim 4, wherein selecting one or more blocks of control applications, is based on one or more of the block level indices which are. At least one of a migration index or a block reliability index.

13. The method as claimed in claim 1, wherein identifying one or more potential slots in one or more destination controllers, is based on one or more of the node level indices which include at least one of an acceptance index, a node reliability index, and a node load index.

14. The method as claimed in claim 1, wherein performing schedulability analysis for each of the one or more blocks or of a logical combination thereof, is based on one or more factors which include time guarantees, execution sequence of the blocks or of the control applications thereof, or overall stability.

15. The method as claimed in claim 11, wherein allowing one or more of dynamic changes is provided which include at least one of adding, deleting, modifying, or cascading of control schemes of a plant, or changes to the logic or algorithm of a control application.

16. The method as claimed in claim 1, being performed online or during operation of the one or more controllers or of a plant thereof, maintaining operation of the one or more controllers or of the plant and of the sequence of operation therein.
